(19) United States
(12) Patent Application Publication
(10) Pub. No.: US 2024/0342960 A1
(43) Pub. Date: Oct. 17, 2024

(54) METHOD AND DEVICE FOR PROCESSING PLASTICS MATERIAL

(71) Applicant: Coperion GmbH, Stuttgart (DE)

(72) Inventor: Felix DREHER, Stuttgart (DE)

(73) Assignee: Coperion GmbH, Stuttgart (DE)

(21) Appl. No.: 18/631,363

(22) Filed: Apr. 10, 2024

(30) Foreign Application Priority Data
Apr. 12, 2023 (EP) 23 167 557.0

(51) Int. Cl. B29B 13/02; B29B 7/00; B29B 7/48; B29K 23/00; B29K 105/00; B29K 105/26

(52) U.S. Cl. CPC B29B 13/022; B29B 7/007; B29B 7/48; B29K 2023/065; B29K 2105/0094; B29K 2105/26

(57) ABSTRACT

Method for processing plastics material, comprising the following steps: feeding the plastics material into a screw machine by means of a feeding device; plasticizing the fed plastics material by means of the screw machine to form a polymer melt; and processing the polymer melt by means of the screw machine, wherein the viscosity of the polymer melt is set by means of the screw speed of the screw machine, and device for processing plastics material.

### CROSS-REFERENCED TO RELATED APPLICATION

This application claims priority to European Application No. 23 167 557.0 filed on Apr. 12, 2023, the entire contents of which are hereby incorporated by reference.

### TECHNICAL FIELD

The disclosure relates to a method for processing plastics material, for example plastics recycling material and/or plastics waste. The disclosure also relates to a device for processing plastics material, such as plastics recycling material and/or plastics waste.

### BACKGROUND

In mechanical recycling, pure polymer material streams are usually melted, homogenized, degassed and then regranulated in a twin-screw extruder. New products can be manufactured from the regranulates obtained. One processing method for regranulates is injection molding, for example, where low viscosities can be processed better due to the high injection pressure. For example, high-density polyethylene (HDPE), as a representative of the recyclable thermoplastic polymers, is only suitable for this process to a limited extent due to its very tough properties. Similar also applies to polypropylene (PP).

It would be desirable if such thermoplastic polymers could also be processed better, thus enabling more applications for recyclable polymers with tough properties. To improve processability, it would be advantageous to reduce the toughness, for example by increasing the melt flow index (MFI). The melt flow index is a measure of viscosity. The toughness can be reduced, for example, either by adding a virgin polymer with a higher melt index or by degrading the plastics material at high temperatures. However, there are three key challenges here. Depending on the product and process, only a narrow range is permissible for the melt flow index. Furthermore, the input viscosity of the plastic material can vary considerably. It is very difficult, if not impossible, to specifically control the resulting melt flow index by adding a virgin polymer. Another disadvantage is the cost of the virgin polymer and its dosage. Furthermore, online measurement of viscosity may not always be available or possible. As a result, during the process one has no knowledge about the melt flow index of the polymer melt and therefore no way of optimally adjusting the melt flow index or viscosity.

### SUMMARY

Embodiments of the disclosure are based on the object of structurally and/or functionally improving a method for processing plastics material mentioned at the outset. Embodiments of the disclosure are also based on the object of structurally and/or functionally improving a device for processing plastics material mentioned at the outset. It is therefore an object of embodiments of the disclosure to provide a processing method and a processing device which reduce or eliminate the problems indicated in connection with the prior art. For example, one object is to be able to optimally compensate for fluctuating input viscosities and/or to be able to maintain and/or set a desired melt flow index.

The object is achieved by a method having the features of claim 1. The object is also achieved by a device having the features of claim 14. Advantageous embodiments and/or further embodiments are the subject matter of the subclaims, the description and/or the accompanying figures. Particularly, the independent claims of one category of claims may also be further defined and/or combined analogously to the dependent claims of another category of claims. The device and method features described below may also be combined with one another and/or further developed.

One aspect relates to a method for processing plastics material. The method may be a processing method. In the method, the plastics material can first be fed into a screw machine. The plastics material can be fed by means of a feeding device and/or metering apparatus. The plastics material may be fed continuously and/or metered. Alternatively, the plastics material may be supplied discontinuously. For example, the plastics material can be fed via a feed opening of the screw machine. In one variant, the feed opening can be a main feed opening, e.g. main inlet, of the screw machine.

The plastics material may be or comprise plastics recycling material. The plastics recycling material can be plastic waste, e.g. end consumer plastics waste (“post consumer waste”). In embodiments, the plastics recycling material is in the form of plastics particles, which can be washed and/or cleaned. Depending on the particle size and/or particle shape, the plastics particles may be in the form of plastics granules, plastics flakes, plastics fibers, or plastics powder, for example. The plastics particles can therefore be a recyclate. The plastics particles may also be shred-shaped and/or flake-shaped. In particular, the plastics recycling material or the plastics particles form bulk material which has been processed or produced, for example, by means of an extrusion and/or granulation system. Alternatively, the plastics recycling material may also have been shredded or ground. Furthermore, the plastics material can have a low bulk density. The plastics material may comprise-in particular, thermoplastic-polymers. The plastics material may comprise or be a polyethylene, for example a high-density polyethylene (HDPE), and/or a polypropylene (PP). For example, the plastics material can comprise or be an HDPE plastics material or PP plastics material.

In the method, the plastics material fed can be plasticized into a polymer melt using the screw machine. Plasticizing can be understood as melting the plastics material. The polymer melt can have a temperature of between 100° C. and 400° C., for example between 300° C. and 400° C., in particular between 350° C. and 390° C., for example about 370° C. The plasticizing can take place and/or the screw machine can be controlled such that a certain melt temperature can be reached and/or maintained. In this case, the plasticizing can take place by means of at least one treatment element shaft of the screw machine, for example in the melting zone and/or mixing zone of the screw machine. The treatment element shaft of the screw machine can be driven at a screw speed or can be driven in such a way that the treatment element shaft has a certain screw speed. The treatment element shaft can be an extruder screw. In one embodiment variant, plasticizing can be carried out by means of two treatment element shafts of the screw machine. The screw machine can therefore be a multi-shaft screw machine, for example a twin-shaft screw machine. The screw machine can be designed as a multi-shaft screw machine which is rotationally driven in the same direction or in opposite directions and/or which is tightly meshing, and can be driven in such a way. The screw machine can be an extruder, in particular a multi-shaft extruder, e.g. twin-screw extruder.

The screw machine can then be used to process the polymer melt. Here, the viscosity of the polymer melt can be set by means of the screw speed of the screw machine. Setting the viscosity can be and/or comprise setting the melt flow index (MFI) of the polymer melt. The melt flow index can be the resulting melt flow index, for example of the product. The viscosity or the melt flow index of the polymer melt can be set, controlled and/or monitored by means of the melt temperature. Here, a relationship between the viscosity or the melt flow index and the melt temperature can be determined and/or specified. The relationship between viscosity or melt flow index and melt temperature can depend on the formulation i.e. can depend on the formulation of the polymer melt and/or the formulation of the plastics material fed. The relationship between viscosity or melt flow index and melt temperature can therefore be determined as a function of the formulation. Furthermore, a relationship between the melt temperature and the screw speed can be determined and/or specified.

During the method, the viscosity or melt flow index of the polymer melt can be increased, maintained or reduced. Additionally or alternatively, the melt temperature of the polymer melt can be increased, maintained or reduced. For example, the viscosity or melt flow index of the polymer melt can be influenced and/or set by increasing, maintaining or decreasing the melt temperature. Here, the viscosity or melt flow index can be increased by increasing the melt temperature, or the viscosity or melt flow index can be reduced by decreasing the melt temperature. Additionally or alternatively, the screw speed of the screw machine can be increased, maintained or reduced. In particular, the melt temperature of the polymer melt can be set and/or regulated by means of the screw speed of the screw machine. Here, the melt temperature can be influenced and/or set by increasing, maintaining or decreasing the screw speed. For example, the melt temperature can be increased by increasing the screw speed, or the melt temperature can be reduced by reducing the screw speed. The screw speed can thus be used to indirectly set the viscosity or melt flow index of the polymer melt. Furthermore, the viscosity or the melt flow index of the polymer melt can be monitored and/or controlled indirectly by means of the melt temperature.

In one embodiment variant, a melt target temperature of the polymer melt can be specified or determined. The melt target temperature can then be set by setting and/or regulating the screw speed. In this case, setting can be understood to mean increasing, maintaining and/or decreasing the screw speed. The viscosity or melt flow index of the polymer melt can thus be set and/or adjusted by means of the melt target temperature. During the method, the melt target temperature can be determined based on a specified or identified formulation of the polymer melt and/or a composition of the plastics material fed and/or a specified target viscosity or a specified target melt flow index. For example, the melt target temperature can be determined continually, in particular at regular time intervals and/or in the case of specified events, or continuously. Here, the specified events can comprise reaching certain process parameters and/or adding new or different plastics material. Furthermore, the regulation and/or setting of the screw speed and/or the determination of the melt target temperature can take place automatically or manually.

In the method, the melt temperature of the polymer melt can be detected, for example continually or continuously. This can be the current or actual melt temperature of the polymer melt. The melt temperature can be detected by means of a temperature sensor. Based on the detected melt temperature, a value for the viscosity or the melt flow index of the polymer melt can then be determined.

In one embodiment variant, at least one additive can be fed to the plastics material and/or the polymer melt. The additive may be or include an additive, excipient, filler, talc, stabilizer, modifier, impact modifier, antioxidant, dye or water. For example, the additive can be in powder, granulate or liquid form. By adding the additive, the viscosity or the melt flow index of the polymer melt can be influenced, in particular increased or decreased. In particular, the additive can be fed into the screw machine. In embodiments, the at least one additive can be mixed into the polymer melt during plasticizing and/or during processing. The additive may be added continuously and/or metered. Alternatively, the additive can be added discontinuously. For example, the additive can be fed via a feed opening of the screw machine. The feed opening can be the main feed opening or a secondary feed opening of the screw machine. The secondary feed opening can be provided before degassing. For example, the additive can be fed into an intake zone, melting zone, and/or mixing zone of the screw machine. The additive can also be added together with the plastics material. In one variant, the additive can be fed downstream of the main feed opening or intake zone of the screw machine. Furthermore, an additive can be fed into both the main feed opening and the secondary feed opening and thus into the intake zone and at least one zone downstream of the intake zone, for example the melting zone and/or mixing zone. In one variant, the additive can be fed by means of a feeding device and/or metering apparatus. The feeding apparatus may be a feeding screw machine. The feeding screw machine can, for example, be designed as an, in particular twin-shaft, side feeder screw machine.

In particular, plasticizing and/or processing the plastics material may comprise the steps of mixing, melting, homogenizing and/or degassing. The processed polymer melt can then be fed to a filter device and/or granulating device or another further processing system, for example.

A further aspect relates to a device for processing plastics material, in particular the plastics material described above and/or below. The plastics material can therefore be, for example, plastics recycling material, in particular HDPE plastics material or PP plastics material. The device may be a processing system.

In embodiments, the device comprises a screw machine having at least one feed opening for feeding the plastics material into the screw machine, and at least one treatment element shaft for plasticizing the plastics material fed into a polymer melt, and for processing the polymer melt. The screw machine can be a multi-shaft screw machine, in particular a multi-shaft extruder. The screw machine can be designed as a multi-shaft screw machine which is rotationally driven and/or in the opposite direction in the same direction. For example, the screw machine can be a twin-shaft screw machine or a double screw extruder.

In particular, the device and/or the screw machine can be designed to set the viscosity and/or the melt flow index of the polymer melt by means of the screw speed of the screw machine. The device can in particular also be further developed having at least one feature which is described in connection with the method. The device and/or the screw machine can thus be configured and intended for carrying out the method described above and/or below.

The at least one treatment element shaft can be an extruder screw. In one embodiment variant, the treatment element shaft can have a diameter and a process length, wherein the process length is at least 36 times the diameter. The treatment element shaft can be a highly restrictive screw, for example having at least three left-hand conveying elements. The screw machine and/or the at least one treatment element shaft can, in particular, be designed to reach a melt temperature of greater than 300° C., in embodiments greater than 360° C. For this purpose, the screw machine can be designed to set a corresponding screw speed.

Furthermore, the device can have a degassing apparatus for degassing the polymer melt. The degassing apparatus can be coupled to the screw machine. Additionally or alternatively, the device may have a water feeding apparatus for feeding water into the polymer melt. The water feeding apparatus can be coupled to the screw machine. Furthermore, the device can have at least one feeding apparatus and/or metering apparatus for feeding at least one additive into the plastics material or into the polymer melt. The feeding apparatus can be or comprise a feeding screw machine, in particular a, for example twin-shaft, side feeder screw machine.

By means of embodiments of the disclosure, fluctuating input viscosities can be optimally compensated for, in particular by means of speed adjustment. Furthermore, a desired melt flow index can be set and/or maintained, for example even if new plastics material or plastics material having a different composition is fed into the screw machine. The degradation of HDPE or the like can take place via a purely mechanical energy input. An addition of virgin polymer for setting the melt flow index is no longer necessary. The proportion of recyclate in the end product can therefore be increased. The use of a viscometer is also no longer absolutely necessary.

### BRIEF DESCRIPTION OF THE DRAWINGS

In the following, exemplary embodiments are described in more detail with reference to figures, in which, schematically and by way of example:

FIG. 1 is a partial sectional view of a device for processing plastics material.

FIG. 1 shows a processing device 100 for processing plastics recycling material 102, in particular HDPE plastics recycling material. The processing device 100 comprises a multi-shaft screw machine 104 which is used for plasticizing the plastics recycling material 102 into a polymer melt 106, and for processing the polymer melt 106.

### DETAILED DESCRIPTION

The multi-shaft screw machine 104 is designed as a unidirectional twin-shaft screw machine. The multi-shaft screw machine 104 comprises a housing 108 made of multiple successively arranged housing portions 110 to 124, which are connected to one another to form the housing 108. Two housing bores 126 which are parallel to one another and penetrate one another are formed in the housing 108, and have the shape of a lying figure eight in cross-section. The multi-shaft screw machine 104 further comprises two treatment element shafts 128 arranged concentrically in the housing bores 126, which can be rotationally driven by a drive motor 130 about associated axes of rotation 132. A branching transmission 134 and a coupling 136 are arranged between the treatment element shafts 128 and the drive motor 130. By means of the drive motor 130, the two treatment element shafts 128 are rotationally driven in the same direction, i.e. in the same directions of rotation, about the axes of rotation 132. The treatment element shafts 128 have a diameter and a process length, wherein the process length is at least 36 times the diameter. The treatment element shafts 128 are further designed for plasticizing the fed plastics recycling material 102 into the polymer melt 106, and for processing the polymer melt 106.

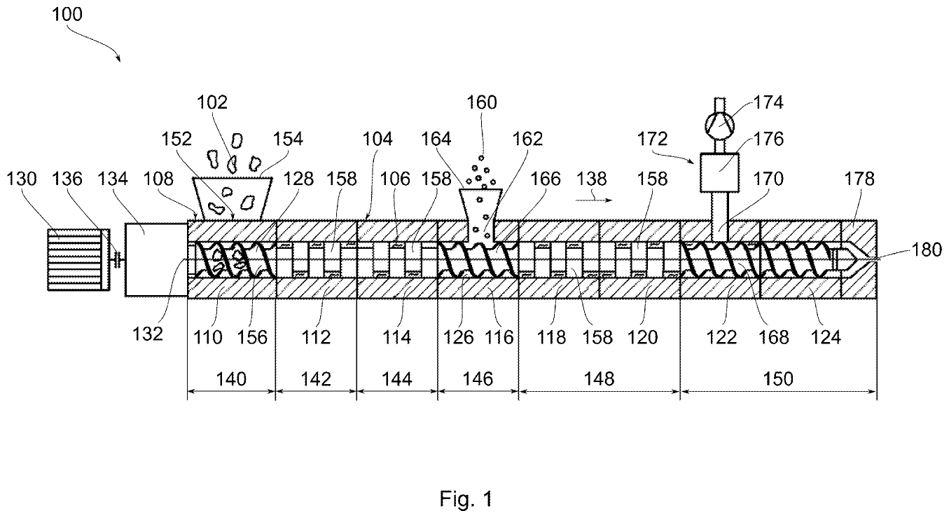

As shown in FIG. 1, the multi-shaft screw machine 104 comprises, in succession in a conveying direction 138, an intake zone 140, a plasticizing zone 142, a homogenization zone 144, a feeding zone 146, a mixing zone 148, and a discharge zone 150.

In the intake zone 140, the housing portion 110 comprises a feed opening 152 having a main intake funnel 154 for feeding the plastics recycling material 102 into the multi-shaft screw machine 104. In the intake zone 140, the treatment element shafts 128 comprise screw elements 156 for conveying the plastics recycling material 102 in the conveying direction 138.

In the plasticizing zone 142, melting of the plastics recycling material 102 takes place. For melting, the treatment element shafts 128 have kneading elements 158, designed as kneading discs, in the plasticizing zone 142. In the plasticizing zone 142, the plastics recycling material 102 is melted to form the polymer melt 106.

In the homogenization zone 144, the polymer melt 106 is homogenized. The treatment element shafts 128 also have kneading elements 158, designed as kneading discs, in the homogenization zone 144.

At least one additive 160 is added to the polymer melt 106 in the feeding zone 146. The additive 160 can be, for example, an additive, a modifier, such as an impact modifier, an antioxidant, a dye, or water. For this purpose, a feed opening 162 is formed in the housing portion 116, into which a feed funnel 164 opens. For example, the additive is fed into the feed funnel 164 by a metering apparatus and/or into the multi-shaft screw machine 104 via a feeding screw machine (not shown in FIG. 1). In the feeding zone 162, the treatment element shafts 128 have screw elements 166, for example conveying screw elements for conveying the polymer melt 106 and the at least one additive 160 in the conveying direction 138.

In the mixing zone 148, the at least one additive 160 is melted and/or mixed into the polymer melt 106. The mixture can thereby be homogenized. The treatment element shafts 128 have kneading elements 158, designed as kneading discs, in the mixing zone 148.

In the discharge zone 150, the treatment element shafts 128 have conveying screw elements 168 for discharging the processed polymer melt 106. Furthermore, a degassing opening 170 is formed in the housing portion 122. The degassing opening 170 is connected to a vacuum degassing apparatus 172, so that the polymer melt 106 is degassed via the degassing opening 170 by means of the vacuum degassing apparatus 172. The vacuum degassing apparatus 172 comprises a vacuum pump 174 which is connected to the degassing opening 170 via a separator 176. A nozzle plate 178 which closes the housing 108 and forms a discharge opening 180 is arranged on the last housing portion 124. A filter device and/or granulating device or another further processing system can be connected to the discharge opening 180 (not shown in further detail in FIG. 1).

The processing device 100 or its multi-shaft screw machine 104 is in particular designed for setting the viscosity and/or the melt flow index of the polymer melt 106 by means of the screw speed of the multi-shaft screw machine 104. The processing of the plastics recycling material 102 by means of the processing device 100 is described below.

The comminuted plastics recycling material 102 is fed, for example by means of a feeding device and via the main intake funnel 154, into the multi-shaft screw machine 104, and then enters the intake zone 140. In the intake zone 140, the plastics recycling material 102 is conveyed, in the conveying direction 138, to the plasticizing zone 142. The plastics recycling material 102 that is fed in is then melted in the plasticizing zone 142 by means of the treatment element shafts 128 or their kneading elements 158, and the polymer melt 106 is homogenized in the homogenization zone 144.

In the feeding zone 146, at least one additive, such as an additive, modifier, antioxidant or water, is added to the polymer melt 106 via the feed opening 162. In the mixing zone 148, the at least one additive is melted and mixed into the polymer melt 106. The mixture can also be homogenized here. Gases escaping from the polymer melt 106 are discharged by means of the vacuum degassing apparatus 172.

During the processing of the polymer melt 106 by the multi-shaft screw machine 104, the viscosity or the melt flow index of the polymer melt 106 is set by means of the screw speed. Here, the melt flow index of the polymer melt 106 is increased, maintained or decreased.

The melt flow index is set or adjusted via the melt temperature, which is set and/or regulated accordingly by setting and/or regulating the screw speed. In embodiments, a melt target temperature of the polymer melt 106 is determined based on a specified or determined formulation of the polymer melt 106 and/or a composition of the plastics recycling material 102 fed and/or a specified target viscosity or respectively a specified target melt index. The melt target temperature can be determined continually, for example at regular time intervals and/or in the case of specified events, or continuously. The actual melt temperature of the polymer melt 106 is detected and/or monitored, in particular continually or continuously, for example by means of a temperature sensor.

The melt target temperature corresponds to a specific target melt flow index. In order to achieve the specified melt target temperature, the screw speed of the treatment element shafts 128 is correspondingly set or regulated, for example increased, maintained or decreased. By adjusting the screw speed, the actual melt temperature of the polymer melt 106 is increased, maintained or decreased accordingly. This has an effect on the melt flow index, so that it is increased, maintained or decreased accordingly. A fluctuating input viscosity can thus be optimally compensated for or set to and maintained at a desired melt flow index. This is advantageous in particular new plastics recycling material, or plastics recycling material with a different composition is fed to the multi-shaft screw machine 104.

The term “may” refers in particular to optional features of embodiments. Accordingly, there are also developments and/or exemplary embodiments which additionally or alternatively have the respective feature or the respective features.

From the feature combinations disclosed in herein, isolated features may also be singled out as required and, by resolving an optionally existing structural and/or functional relationship between the features in combination with other features, be used to delimit the subject matter of the claim. The order and/or number of method steps may be varied.

### REFERENCE SIGNS

100 Processing device
102 Plastics recycling material
104 Multi-shaft screw machine
106 Polymer melt
108 Housing
110-124 Housing portions
126 Housing bores
128 Treatment element shafts
130 Drive motor
132 Axes of rotation
134 Branching transmission
136 Coupling
138 Conveying direction
140 Intake zone
142 Plasticizing zone
144 Homogenization zone
146 Feeding zone
148 Mixing zone
150 Discharge zone
152 Feed opening
154 Main intake funnel
156 Conveying screw elements
158 Kneading elements
160 Additive
162 Feed opening
164 Feed funnel
166 Screw elements
168 Conveying screw elements
170 Degassing opening
172 Vacuum degassing apparatus
174 Vacuum pump
176 Separator
178 Nozzle plate
180 Discharge opening

What is claimed is:

1. A method for processing plastics material, comprising the following steps:
feeding the plastics material into a screw machine by means of a feeding device;
plasticizing the fed plastics material by means of the screw machine to form a polymer melt; and
processing the polymer melt by means of the screw machine, wherein a viscosity of the polymer melt is set by means of a screw speed of the screw machine.

2. The method according to claim 1, wherein the setting of the viscosity is and/or comprises setting a melt flow index of the polymer melt.

3. The method according to claim 2, wherein
the viscosity or the melt flow index of the polymer melt is increased, maintained or decreased, and/or in that
a melt temperature of the polymer melt is increased, maintained or decreased, and/or in that
the screw speed of the screw machine is increased, maintained or decreased.

4. The method according to claim 1, wherein a melt temperature of the polymer melt is set and/or regulated by means of the screw speed of the screw machine.

5. The method according to claim 1, wherein a melt target temperature of the polymer melt is specified or determined, which melt target temperature is then set by setting and/or regulating the screw speed.

6. The method according to claim 5, wherein the melt target temperature is determined based on a specified or identified formulation of the polymer melt and/or a composition of the plastics material fed and/or a specified target viscosity or respectively a specified target melt flow index.

7. The method according to claim 5, wherein the melt target temperature is determined continually, in particular at regular time intervals and/or in the case of specified events, or continuously.

8. The method according to claim 5, wherein the viscosity or a melt flow index of the polymer melt is set and/or adjusted by means of the melt target temperature.

9. The method according to claim 1, wherein regulation of the screw speed and/or a determination of a melt target temperature takes place automatically.

10. The method according to claim 1, wherein a melt temperature of the polymer melt is detected, in particular continually or continuously, in particular by means of a temperature sensor.

11. The method according to claim 10, wherein a value for the viscosity or a melt flow index of the polymer melt is determined based on the detected melt temperature.

12. The method according to claim 1, wherein at least one additive is added to the plastics material and/or the polymer melt, and/or in that the polymer melt is homogenized and/or degassed and/or fed to a filter device and/or granulating device.

13. The method according to claim 1, wherein the screw machine is a multi-shaft screw machine, in particular a twin-shaft screw machine.

14. A device for processing plastics material, comprising a screw machine, in particular a multi-shaft screw machine, comprising
at least one feed opening for feeding the plastics material into the screw machine; and
at least one treatment element shaft for plasticizing the fed plastics material into a polymer melt and for processing the polymer melt,
wherein the device and/or screw machine is designed to set a viscosity and/or a melt flow index of the polymer melt by means of a screw speed of the screw machine.

15. The device according to claim 14, wherein the at least one treatment element shaft has a diameter and a process length, wherein the process length is at least 36 times the diameter.
